(19) United States
(12) Patent Application Publication
(10) Pub. No.: US 2024/0330538 A1
(43) Pub. Date: Oct. 3, 2024

(54) LIGHTWEIGHT METHOD FOR BACK FRAME OF PHASED ARRAY RADAR ANTENNA

(71) Applicant: HUNAN UNIVERSITY, CHANGSHA (CN)

(72) Inventors: Bingyu NI, CHANGSHA (CL); Weiwei CHEN, CHANGSHA (CN); Zhonghua WANG, CHANGSHA (CN); Wanyi TIAN, CHANGSHA (CN); Chao JIANG, CHANGSHA (CN)

(21) Appl. No.: 18/579,970

(22) PCT Filed: Apr. 22, 2022
(86) PCT No.: PCT/CN2022/088417

§ 371 Date: Jan. 17, 2024

(30) Foreign Application Priority Data
Jul. 22, 2021 (CN) 202110831603.6

(51) Int. Cl. G06F 30/20; G06F 119/02; G06F 119/14

(52) U.S. Cl. CPC G06F 30/20; G06F 2119/02; G06F 2119/14

(57) ABSTRACT

The present application discloses a lightweight method for a back frame of phased array radar antenna. The method includes: step 1: establishing a back frame lightweight reliability model; step 2: calculating a displacement constraint condition and reliability indicating that displacement amount maximum value of the back frame of antenna does not exceed a displacement threshold; and step 3: calculating a maximum probability failure point of a displacement constraint condition after a Lagrangian transformation under a preset condition, and calculating an optimal solution of the back frame lightweight reliability model, to determine a phased array radar antenna lightweight reliability parameter. Through technical solutions in the present application, the problem that it is difficult to obtain an accurate probability model of a phased array radar antenna back frame is resolved, thereby a calculation amount in a reliability optimization process is greatly reduced.

### CROSS-REFERENCE TO RELATED APPLICATIONS

The present application claims the priority of China Invention application Ser. No. 20/211,0831603.6, titled “LIGHTWEIGHT METHOD FOR BACK FRAME OF PHASED ARRAY RADAR ANTENNA” filed on Jul. 22, 2021.

### TECHNICAL FIELD

The present application relates to the technical field of phased array radars, and specifically, to a lightweight method for a back frame of phased array radar antenna.

### BACKGROUND

A phased array radar is widely applied to important fields. A back frame of phased array radar antenna is used as a carrier for a radar surface, and plays a decisive role in normal operation of the phased array radar. Due to the impact of uncertainty factors such as a service environment (a wind load and a sleet load), a structural size, and an installation deviation, a deformation in the back frame of phased array radar antenna may occur, and cause a change to a flatness of the radar surface, to further cause a deterioration in antenna electrical performance, resulting in a large deviation in the detection of a target.

To prevent the impact of these uncertainty factors from making a surface flatness of the phased array radar fail to meet a requirement or causing a failure, therefore, during the design of a back frame of phased array radar antenna, a reliability of a back frame structure needs to be optimized, to ensure that the surface flatness of the phased array radar meets its requirement.

In addition, in consideration of factors in aspects such as production costs, transportation costs, and operating costs of a phased array radar, in a reliability optimization process of a back frame, it is desired that the weight of back frame of antenna is as light as possible while the back frame of antenna meets a flatness requirement.

In the prior art, in most reliability optimization methods, uncertainty parameters in a phased array radar antenna are accurately described by using a probability model, to further measure uncertainty in a structure of a back frame of phased array radar antenna.

As a result, the following problems exist in a reliability optimization process:
1. A large amount of experimental data is required to construct an accurate probability model. For a phased array radar antenna, it is apparently not realistic to obtain a large amount of experimental data in a manner of site measurement or experiment. Therefore, it is very difficult to obtain an accurate probability model to describe uncertainty parameters during installation and normal operation of a phased array radar.
2. In a conventional reliability optimization method, because of multi-layer nesting in an algorithm of the method, a calculation amount is very huge. Furthermore, during reliability optimization with a lightweight back frame mass as a target function, because it is difficult to obtain an accurate probability model, the algorithm is complex, and there are a large number of impact factors, a final solution usually fails to be obtained, and the design efficiency of the phased array radar antenna is further affected.

### SUMMARY

An objective of this application lies in that a structural reliability of a back frame of phased array radar antenna is measured and optimized by using an interval-probability uncertainty measurement model, using a minimum total weight of a back frame as a target function, and using limited samples, to provide more effective guidance and reference for overall design and performance optimization of a phased array radar.

### The Technical Solution

The present application provides a lightweight method for a back frame of phased array radar antenna. The method includes:
step 1: establishing a lightweight reliability model of back frame of phased array radar antenna using an interval-probability uncertainty measurement model based on measured parameters of a back frame of phased array radar antenna;
step 2: based on an equivalence model principle and according to a displacement function of the antenna back frame in the lightweight reliability model of back frame of phased array radar antenna, calculating a reliability indicating that a displacement amount maximum value of the antenna back frame does not exceed a displacement threshold, and performing a conversion operation on the reliability based on a reliability lower boundary to calculate a displacement constraint condition; and
step 3: performing a Lagrangian transformation on the displacement constraint condition, calculating a maximum probability failure point of a displacement constraint condition after its Lagrangian transformation under a preset condition by using an iterative operation, and calculating an optimal solution of the back frame lightweight reliability model according to the maximum probability failure point, to determine a phased array radar antenna lightweight reliability parameter.

In above technical solution, additionally, step 2 includes:
step 21: converting an uncertainty variable in the lightweight reliability model of back frame of phased array radar antenna into a standard normal random variable;
step 22: equivalently replacing a reliability coefficient of the reliability with a reliability coefficient lower boundary; and
step 23: calculating the displacement constraint condition corresponding to an index lower boundary of the displacement function based on an equivalently replaced reliability.

In above technical solutions, additionally, a calculation formula of the displacement constraint condition is:

$${min}_{U , Y} G ( U , Y )$$

$$s . t .$$

$${‖ U ‖}_{2} = {β}^{t} ,$$

$$and$$

$${‖ Y ‖}_{p} \leq 1 ,$$

wherein, G (U, Y) is the displacement constraint condition, U is the standard normal random variable, ∥ ∥₂ is a second norm of a vector, β^{t} is a target reliability coefficient, p is a hyperparameter, ∥·∥ₚ is a p norm operation of a vector, and Y is a standard interval variable.

In any of above technical solutions, additionally, the preset condition is one of a first condition and a second condition, and said step 3 specifically comprises:
step 31: calculating an initial design parameter of the back frame of phased array radar antenna in a certainty parameter;
step 32: when the preset condition is the first condition, determining a corresponding first KKT condition according to the first condition and a displacement constraint condition after the Lagrangian transformation, and performing an equivalence transformation on the back frame lightweight reliability model according to the first KKT condition, to calculate the maximum probability failure point; and
step 34: calculating a solution of a certainty model part in the back frame lightweight reliability model according to the calculated maximum probability failure point, wherein the solution is denoted as the optimal solution of the back frame lightweight reliability model.

In any of above technical solutions, said step 3 specifically further comprises:
step 33: when the preset condition is the second condition, determining a corresponding second KKT condition according to the second condition and the displacement constraint condition after the Lagrangian transformation, and performing the equivalence transformation on the back frame lightweight reliability model according to the second KKT condition, to calculate the maximum probability failure point.

In any of above technical solutions, said step 3 further comprises:
when it is determined that a k^{th} maximum probability failure point calculated in a k^{th} iterative operation converges, calculating the optimal solution of the back frame lightweight reliability model according to the k^{th} maximum probability failure point, wherein a calculation formula for determining whether the k^{th} maximum probability failure point converges is:

$$G ( {U}^{( k )} , {Y}^{( k )} ) \geq - {ε}_{1} ,$$

$$and$$

$$\vert \frac{M ( {d}^{( k )} , {μ}_{X}^{( k )} , {μ}_{P} ) - M ( {d}^{( k - 1 )} , {μ}_{X}^{( k - 1 )} , {μ}_{P} )}{M ( {d}^{( k )} , {μ}_{X}^{( k )} , {μ}_{P} )} \vert \leq {ε}_{2} ,$$

wherein in the formula, −ε₁ is an error upper threshold, ε₂ is an error lower threshold, G (·) is a corresponding displacement constraint condition when the k^{th} iterative operation, U^{(k)} is a standard normal random variable in a process of the k^{th} iterative operation, Y^{(k)} is a standard interval variable in the process of the k^{th} iterative operation, M(·) is the lightweight reliability model of back frame of phased array radar antenna, (d^{(k)}, μ_{X}^{(k)}) is an optimal solution in the process of the k^{th} iterative operation, d^{(k)} is a certainty optimization variable in the process of the k^{th} iterative operation, μ_{X}^{(k)} is an average value of uncertainty optimization variable in the process of the k^{th} iterative operation, and μₚ is an average value of uncertainty parameter.

In any of above technical solutions, a calculation formula of the lightweight reliability model of back frame of phased array radar antenna is:

$${min}_{d , {μ}_{X}} M ( d , {μ}_{X} , {μ}_{P} ) ,$$

$$s . t .$$

$$Pr ( {δ}_{0} - δ ( d , Z ( {θ}_{Z}^{I} ) ) \geq 0 ) \geq {R}^{t} ,$$

$${d}^{l} \leq d \leq {d}^{u} ,$$

$${μ}_{X}^{l} \leq {μ}_{X} \leq {μ}_{X}^{u} ,$$

$$Z ( {θ}_{Z}^{I} ) = ( X ( {θ}_{X}^{I} ) , P ( {θ}_{P}^{I} ) ) ,$$

$${θ}_{Z}^{I} = ( {θ}_{X}^{I} , {θ}_{P}^{I} ) ,$$

$$and$$

$${θ}_{X}^{I} = [ {θ}_{X}^{I} , {θ}_{X}^{u} ] ,$$

$${θ}_{P}^{I} = [ {θ}_{P}^{I} , {θ}_{P}^{u} ] ,$$

in the formula, M (d, μ_{X}, μₚ) is a total weight of the antenna back frame, and at the same time is also a back frame lightweight target function, d is a certainty optimization variable, μ_{X} is an average value of an uncertainty optimization variable X(θ_{X}^{I}), μₚ is the average value of the uncertainty parameter P(θ_{P}^{I}), Pr(·) is a probability measure, δ₀ is the displacement threshold, δ(·) is the displacement function of the antenna back frame, Z(θ_{Z}^{I}) is the uncertainty variable in the back frame lightweight reliability model, R^{t} is a reliability parameter that the displacement amount maximum value of the antenna back frame does not exceed the displacement threshold, θ_{Z}^{I} is a first parameter, and is determined by a second parameter θ_{X}^{I} and a third parameter θ_{P}^{I}, (·)^{l} is a lower boundary of a parameter, and (·)^{u} is an upper boundary of a parameter.

The beneficial effects of the present application are as follows:

In the technical solutions in the present application, a reliability optimization model with a lightweight back frame of phased array radar antenna as a target function is established by using an interval-probability uncertainty measurement model, then an existing reliability constraint condition is converted into a certainty constraint by using a KKT optimal condition, and a multi-layer nesting algorithm in the reliability optimization process is converted into a series of certainty optimization problems, to resolve the problem that it is difficult to obtain an accurate probability model of a back frame of phased array radar antenna, thereby greatly reducing a calculation amount of the reliability optimization process.

In a preferred implementation of the present application, uncertainty factors in a phased array radar are measured by using an interval-probability hybrid measurement model, to establish a more flexible optimization model, thereby reducing the dependence on phased array radar data samples to some extent. Furthermore, to efficiently solve the multi-layer nesting model, a single cycle method is provided, so that a calculation amount can be greatly reduced, to provide a group of appropriate design results for the design of a phased array radar, and the method has feasibility, economical efficiency, and actual engineering application value.

### BRIEF DESCRIPTION OF THE DRAWINGS

The advantages in the foregoing and/or additional aspects of the present application will become apparent and more comprehensible from the following description of the embodiments with reference to the accompanying drawings.

FIG. 1 is a schematic flowchart of a lightweight method for a back frame of phased array radar antenna according to an embodiment of the present application;

FIG. 2 is a schematic diagram of a back frame of phased array radar antenna according to an embodiment of the present application; and

FIG. 3 is a simulated diagram of an optimal solution of a back frame of phased array radar antenna according to an embodiment of the present application.

### DETAILED DESCRIPTION

To make the objectives, features, and advantages of the present application more comprehensible, the present application is further described below in detail with reference to the accompanying drawings and specific implementations. It needs to be noted that the embodiments in the present application and the features in the embodiments may be combined with each other without causing any conflict.

In the following descriptions, many specific details are described to make the present application fully comprehensible. However, the present application may be implemented in other manners different from those described herein. Therefore, the protection scope of the present application is not limited to specific embodiments disclosed below.

It is set in this embodiment that an interval-probability uncertainty measurement model is used to measure an uncertainty variable with insufficient samples of a back frame of phased array radar antenna, and a corresponding model is:

{X|X˜F(X,θ^{l})},

where in the formula, X is a random variable, F (X, θ^{l}) is a cumulative density distribution function of the random variable X, and θ^{l} is a parameter in the cumulative density distribution function. However, because the samples are insufficient, the parameter θ^{l} is not a fixed value, but instead is an interval with an upper boundary and a lower boundary.

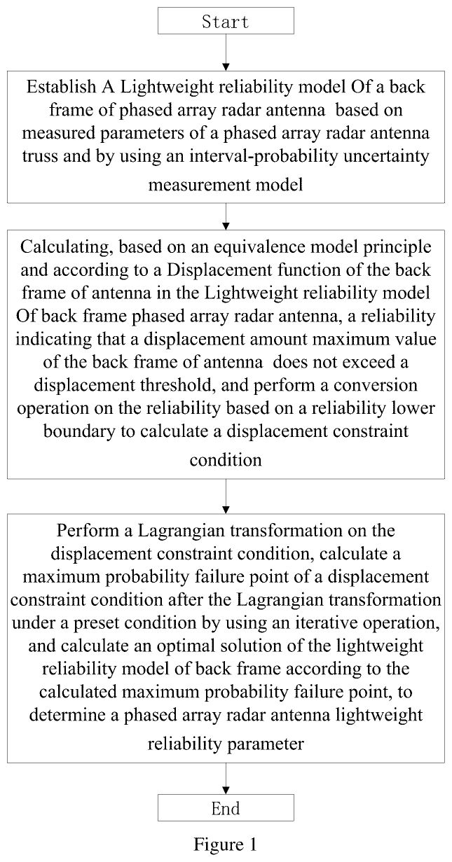

As shown in FIG. 1, this embodiment provides a lightweight method for a back frame of phased array radar antenna, including:

Step 1: Establish a lightweight reliability model of back frame of phased array radar antenna based on measured parameters of a back frame of phased array radar antenna and by using an interval-probability uncertainty measurement model. The back frame lightweight reliability model at least includes a design variable, an uncertainty variable, a back frame lightweight target function, a reliability constraint function, and a probability measure of the back frame of phased array radar antenna.

In this embodiment, a calculation formula corresponding to the back frame lightweight reliability model is:

$${min}_{d , {μ}_{X}} M ( d , {μ}_{X} , {μ}_{P} ) ,$$

$$s . t .$$

$$Pr ( {δ}_{0} - δ ( d , Z ( {θ}_{Z}^{I} ) ) \geq 0 ) \geq {R}^{t} ,$$

$${d}^{l} \leq d \leq {d}^{u} ,$$

$${μ}_{X}^{l} \leq {μ}_{X} \leq {μ}_{X}^{u} ,$$

$$Z ( {θ}_{Z}^{I} ) = ( X ( {θ}_{X}^{I} ) , P ( {θ}_{P}^{I} ) ) ,$$

$${θ}_{Z}^{I} = ( {θ}_{X}^{I} , {θ}_{P}^{I} ) ,$$

$$and$$

$${θ}_{X}^{I} = [ {θ}_{X}^{I} , {θ}_{X}^{u} ] ,$$

$${θ}_{P}^{I} = [ {θ}_{P}^{I} , {θ}_{P}^{u} ] ,$$

wherein in the formula, M (d, μ_{X}, μₚ) is a total weight of the back frame of antenna, and at the same time is also a back frame lightweight target function, and d is a certainty optimization variable, for example, an overall size (a maximum length and a maximum width of the back frame) of the back frame of antenna. Because variances are small during production and manufacturing of the back frame of antenna, and nearly have no impact on the overall size, it may be approximated as the certainty optimization variable.

μ_{X} is an average value of an uncertainty optimization variable X(θ_{X}^{I}), and up is an average value of an uncertainty parameter P(θ_{P}^{I}).

Pr(·) is the probability measure. δ₀ is a displacement threshold, and the displacement threshold δ₀ is a maximum displacement amount of the back frame of antenna required in a design. δ(·) is a displacement function of the back frame of antenna. Z(θ_{Z}^{l}) is an uncertainty variable in the back frame lightweight reliability model, and is formed by combining the uncertainty optimization variable X(θ_{X}^{l}) and the uncertainty parameter P(θ_{P}^{I}). R^{t} is a reliability parameter indicating that a displacement amount maximum value of the back frame of antenna does not exceed the displacement threshold.

d^{l} is a lower boundary of the certainty optimization variable d. d^{u} is an upper boundary of the certainty optimization variable d. μ_{X}^{l} is a lower boundary of an average value μ_{X} of the uncertainty optimization variable. μ_{X}^{u} is an upper boundary of the average value μ_{X} of the uncertainty optimization variable. θ_{Z}^{I} is a first parameter, and is determined by a second parameter θ_{X}^{I} and a third parameter θₚ^{I}. The first parameter θ_{Z}^{l} is an interval parameter of a cumulative probability density distribution function for measuring the uncertainty variable Z (θ_{Z}^{l}). The second parameter θ_{X}^{I} is an interval parameter of a cumulative probability density distribution function for measuring the uncertainty optimization variable X(θ_{X}^{I}). The third parameter Op is an interval parameter of a cumulative probability density distribution function for measuring the uncertainty parameter P(θ_{P}^{I}). θ_{X}^{l} is a lower boundary of the second parameter θ_{X}^{I}. θ_{X}^{u} is an upper boundary of the second parameter θ_{X}^{I}. θ_{P}^{l} is a lower boundary of the third parameter θ_{P}^{I}. θ_{P}^{u} is an upper boundary of the third parameter op.

The back frame lightweight reliability model in this embodiment is a nesting model, wherein an outer-layer optimum search model is used to iterate a design point, and at the same time, an inner-layer uncertainty constraint condition needs to be used to analyze a reliability of each iterative point (design point), to finally obtain an optimal solution that meets an inner-layer reliability requirement. The outer-layer optimum search model may be expressed as:

$${min}_{d , {μ}_{X}} M ( d , {μ}_{X} , {μ}_{P} ) ,$$

$$s . t .$$

$$Pr ( {δ}_{0} - δ ( d , Z ( {θ}_{Z}^{I} ) ) \geq 0 ) \geq {R}^{t} ,$$

$$and$$

$${d}^{l} \leq d \leq {d}^{u} ,$$

$${μ}_{X}^{l} \leq {μ}_{X} \leq {μ}_{X}^{u} .$$

The inner-layer uncertainty constraint condition may be expressed as:

$$Z ( {θ}_{Z}^{I} ) = ( X ( {θ}_{X}^{I} ) , P ( {θ}_{P}^{I} ) ) ,$$

$${θ}_{Z}^{I} = ( {θ}_{X}^{I} , {θ}_{P}^{I} ) ,$$

$${θ}_{X}^{I} = [ {θ}_{X}^{l} , {θ}_{X}^{u} ] ,$$

$${θ}_{P}^{I} = [ {θ}_{P}^{l} , {θ}_{P}^{u} ] .$$

It needs to be noted that, a large amount of complex integral calculation needs to be performed to directly calculate the probability measure Pr(·). Therefore, approximate calculation is usually performed by using a First Order Second Moment (FOSM) method to obtain a reliability. In a conventional probability model, based on a First Order Second Moment (FOSM), a lightweight model may be converted into two corresponding equivalence models, which are respectively a Reliability Index Approach (RIA) equivalence model and a Performance Measurement Approach (PMA) equivalence model.

(1) The principle of the RIA equivalence model is that in an uncertainty optimization process, a corresponding average value point in each iterative step is calculated to calculate a reliability coefficient β*. Through equivalent replacement, the reliability parameter R^{t} is converted into a corresponding target reliability coefficient β^{t}. If at this time the reliability coefficient β* is greater than the target reliability coefficient β^{t}, the reliability meets a requirement. That is, the reliability coefficient β* is used to measure whether the reliability meets a requirement.

(2) The PMA equivalence model is developed based on the RIA equivalence model. The basic concept of the PMA equivalence model is to calculate a maximum displacement of the back frame of antenna in a case that the reliability coefficient β* is the target reliability coefficient β^{t} in each iterative step. If a value of the displacement is less than a set maximum displacement threshold, the reliability meets a requirement. That is, when the reliability coefficient β* is used as the target reliability coefficient β^{t}, whether the maximum displacement of the back frame of antenna is less than the displacement threshold δ₀ is used to measure whether the reliability meets a requirement.

Therefore, in this embodiment, the PMA equivalence model is extended from the conventional probability model into the interval-probability uncertainty measurement model. That is, in a case that a probability requirement is met, the maximum displacement of the back frame of antenna at this time is calculated. If the maximum displacement at this time is less than the set displacement threshold, the reliability requirement is met.

Step 2: Calculate, based on an equivalence model principle and according to a displacement function of the back frame of antenna in the lightweight reliability model of back frame of phased array radar antenna, a reliability indicating that a displacement amount maximum value of the back frame of antenna does not exceed a displacement threshold, and perform a conversion operation on the reliability based on a reliability lower boundary to calculate a displacement constraint condition.

Step 2 specifically includes the following steps.

Step 21: Convert an uncertainty variable in the lightweight reliability model of back frame of phased array radar antenna into a standard normal random variable.

Specifically, for a determined cumulative probability function parameter θ*, in a process of calculating a reliability R* of the parameter, an uncertainty variable Z needs to be converted into a standard normal random variable U, and a corresponding conversion formula is:

$$T ( U , {θ}^{*} ) = [ {F}_{{Z}_{1}}^{- 1} ( Φ ( {U}_{1} ) , {θ}^{*} ) , … , {F}_{{Z}_{i}}^{- 1} ( Φ ( {U}_{i} ) , {θ}^{*} ) , … , {F}_{{Z}_{{n}_{Z}}}^{- 1} ( Φ ( {U}_{{n}_{Z}} ) , {θ}^{*} ) ] ,$$

$$Φ ( {U}_{i} ) = {F}_{{Z}_{i}} ( {Z}_{i} , {θ}^{*} ) ,$$

$$and$$

$${Z}_{i} = {F}_{{Z}_{i}}^{- 1} ( Φ ( {U}_{i} ) , {θ}^{*} ) ,$$

$$i = 1 , 2 , … , {n}_{Z} ,$$

wherein in the formula, T(·) is a probability conversion function for converting the standard normal random variable U into a random variable Z. U is the standard normal random variable. F_{Z}_{ᵢ}⁻¹(·) is an inverse function of F_{Z}_{ᵢ}(·). F_{Z}_{ᵢ}(·) is a cumulative distribution density function. F_{Z}_{ᵢ}⁻¹(Zᵢ, θ*) is a cumulative distribution density of an i^{th} random variable Zᵢ.

It needs to be noted that, the reliability R* may be calculated through approximation using a First Order Second Moment (FOSM).

In this embodiment, a calculation formula of the reliability is:

$${R}^{*} = Φ ( {β}^{*} ) ,$$

$${β}^{*} = {min}_{U} {‖ U ‖}_{2} ,$$

$$and s . t .$$

$${δ}_{0} - δ ( d , T ( U , {θ}^{*} ) ) = 0 ,$$

wherein in the formula, R* is the reliability. Φ(·) is a cumulative distribution function of a standard normal distribution. β* is the reliability coefficient. ∥ ∥₂ is a second norm of a vector. U is the standard normal random variable. T(·) is the probability conversion function for converting the standard normal random variable U into the random variable Z. θ* is the cumulative probability function parameter. θ*∈θ_{Z}^{l}. δ(d, T (U, θ*)) is the displacement function of the back frame of antenna corresponding to the standard normal random variable U. d is the certainty optimization variable.

It needs to be noted that, the reliability coefficient β* is determined by a certainty parameter(s).

Step 22: Equivalently replace a reliability coefficient β* of a reliability R* with a reliability coefficient lower boundary β^{l}.

Specifically, to ensure that a deformation amount of the back frame of phased array radar antenna does not exceed a maximum requirement deformation amount, the reliability coefficient lower boundary β^{l} is generally used to equivalently replace the reliability coefficient β* to describe the reliability R*. If a minimum value (the reliability coefficient lower boundary β^{l}) of the reliability coefficient meets its requirement, the system is definitely safe. A calculation formula corresponding to the reliability coefficient lower boundary β^{l} is:

$${β}^{l} = {min}_{U , θ} {‖ U ‖}_{2} ,$$

$$s . t .$$

$${δ}_{0} - δ ( d , T ( U , θ ) ) = 0 ,$$

$$and$$

$$θ ∈ {θ}_{Z}^{I} ,$$

wherein in the formula, θ is an interval parameter, and is a parameter with an interval value in a cumulative distribution function (CDF).

It needs to be noted that, the reliability coefficient lower boundary β^{l} is determined by an uncertainty parameter.

Step 23: Calculate the displacement constraint condition corresponding to an index lower boundary of the displacement function based on an equivalently replaced reliability R*.

A person skilled in the art can understand that a displacement function measure index δ^{P} corresponding to the displacement function δ(·) is also an interval, that is, δ^{P}∈[δ^{Pl}, δ^{Pu}]. Based on the same reason, a displacement function index lower boundary δ^{Pl} is used to equivalently replace a displacement condition in the reliability R*, and a corresponding calculation formula is:

$${δ}^{Pl} = {min}_{U , θ} {δ}_{0} - δ ( d , T ( U , θ ) ) ,$$

$$s . t .$$

$${‖ U ‖}_{2} = {β}^{t} ,$$

$$and$$

$$θ ∈ {θ}_{Z}^{I} ,$$

wherein in the formula, δ^{Pu} is a displacement function index upper boundary, and β^{t} is the target reliability coefficient.

To better describe the interval parameter θ, the interval parameter θ is converted into a standard interval variable Y, and a corresponding calculation formula is:

$$Y = \frac{θ - {θ}_{Z}^{m}}{{θ}_{Z}^{r}} , and \\ Y ∈ [ - 1 , 1 ] ,$$

wherein in the formula, θ_{Z}^{m} is a central point of the first parameter θ_{Z}^{I}, and θ_{Z}^{r} is a radius of the first parameter θ_{Z}^{I}. Y is the standard interval variable, that is, Y∈[−1, 1]. In addition, a dimensionality of the standard interval variable Y in this embodiment is consistent with that of the random variable, and is an n_{Z}-dimension vector.

Therefore, the displacement constraint condition in the reliability R* may be converted into:

$${δ}_{0} - δ ( d , T ( U , θ ) ) = G ( U , Y ) ,$$

wherein in the formula, G (U, Y) is a displacement constraint condition that satisfies the standard normal random variable U and the standard interval variable Y, δ₀ is the displacement threshold, δ(·) is the displacement function of the back frame of antenna, d is the certainty optimization variable, and θ is the interval parameter.

Further, the standard interval variable Y is approximately rewritten by using a hyperparameter convex model, and a calculation formula of the rewritten approximated variable is:

$${‖ Y ‖}_{p} = {( {\sum }_{i = 1}^{{n}_{Z}} {\vert {Y}_{i} \vert}^{p} )}^{\frac{1}{p}} \leq 1 ,$$

wherein in the formula, p is a hyperparameter, ∥·∥ₚ is a p norm operation of a vector, and Yᵢ is a value of an i^{th} dimensionality of the standard interval variable Y.

When p=2, the hyperparameter convex model is degraded into an ordinary elliptical convex model. When p→∞, the hyperparameter convex model can accurately describe the standard interval variable Y∈[−1, 1]. When 2<p<∞, the hyperparameter convex model expresses a rounded square, and when a value of p is larger, the model can more accurately describe the standard interval variable Y∈[−1,1].

Therefore, a calculation formula corresponding to the displacement constraint condition is:

$${min}_{U , Y} G ( U , Y ) , \\ s . t . {‖ U ‖}_{2} = {β}^{t} , and \\ {‖ Y ‖}_{p} \leq 1 ,$$

wherein in the formula, G (U, Y) is the displacement constraint condition, U is the standard normal random variable, ∥ ∥₂ is the second norm of the vector, β^{t} is the target reliability coefficient, p is the hyperparameter, ∥·∥ₚ is the p norm operation of the vector, and Y is the standard interval variable.

Step 3: Perform a Lagrangian transformation on the displacement constraint condition G (U, Y), calculate a maximum probability failure point of a displacement constraint condition after the Lagrangian transformation under a preset condition by using an iterative operation, and calculate an optimal solution of the back frame lightweight reliability model according to the calculated maximum probability failure point, to determine a phased array radar antenna lightweight reliability parameter. The preset condition is one of a first condition and a second condition:
the first condition is: ∥U*∥₂=β^{t} and ∥Y*∥ₚ<1; and
the second condition is: ∥U*∥₂=β^{t} and ∥Y*∥ₚ=1.

In the formula, ∥ ∥₂ is the second norm of the vector, ∥·∥ₚ is the p norm operation of the vector, and (U*, Y*) is a maximum probability failure point.

Step 31: Calculate initial design parameter(s) of the back frame of phased array radar antenna in a certainty parameter.

Specifically, seeking the solution of the displacement constraint condition G (U, Y) is to obtain a maximum probability failure point of a design point. However, at the very start, there is no corresponding design point. Therefore, the maximum probability failure point is not obtained. Therefore, at this time, the maximum probability failure point is set to a 0 vector, and then an optimization model is solved to obtain an initial design parameter [d⁽⁰⁾, μ_{X}⁽⁰⁾].

Step 32: When the preset condition is the first condition, determine a first KKT condition corresponding maximum probability failure point according to the first condition and a displacement constraint condition after the Lagrangian transformation, and perform an equivalence transformation on the back frame lightweight reliability model according to the first KKT condition, to calculate the maximum probability failure point. A calculation formula of a maximum probability failure point that meets the first condition is:

$${U}^{( k + 1 )} = - {β}^{t} \frac{{∇}_{U} G ( {U}^{( k )} , {Y}^{( k )} )}{{‖ {∇}_{U} G ( {U}^{( k )} , {Y}^{( k )} ) ‖}_{2}} , and \\ \{ \begin{matrix}{∇}_{{Y}_{1}} G ( {U}^{( k + 1 )} , {Y}^{( k + 1 )} ) = 0 \\ {∇}_{{Y}_{2}} G ( {U}^{( k + 1 )} , {Y}^{( k + 1 )} ) = 0 \\ … \\ {∇}_{{Y}_{i}} G ( {U}^{( k + 1 )} , {Y}^{( k + 1 )} ) = 0 \\ … \\ {∇}_{{Y}_{{n}_{Z}}} G ( {U}^{( k + 1 )} , {Y}^{( k + 1 )} ) = 0 \\ {Y}^{( k + 1 )} ∈ ( - 1 , 1 )\end{matrix} .$$

Specifically, the foregoing Lagrangian function is:

$$L ( U , Y , {λ}_{1} , {λ}_{2} ) = G ( U , Y ) + {λ}_{1} ( {‖ U ‖}_{2} - {β}^{t} ) + {λ}_{2} ( {‖ Y ‖}_{p} - 1 ) ,$$

wherein in the formula, L(·) denotes a Lagrangian function corresponding to a constraint of the back frame of antenna, U is the standard normal random variable, Y is the standard interval variable, and λ₁ and λ₂ are respectively a first Lagrangian multiplier and a second Lagrangian multiplier.

When the first condition is met, a maximum probability failure point (U*, Y*) needs to meet the following first KKT condition:

$$\{ \begin{matrix}{∇}_{U} L ( {U}^{*} , {Y}^{*} , {λ}_{1} , {λ}_{2} ) = 0 \\ {∇}_{Y} L ( {U}^{*} , {Y}^{*} , {λ}_{1} , {λ}_{2} ) = 0 \\ {∇}_{{λ}_{1}} L ( {U}^{*} , {Y}^{*} , {λ}_{1} , {λ}_{2} ) = 0 \\ {λ}_{2} ( {‖ {Y}^{*} ‖}_{p} - 1 ) = 0 \\ {‖ {Y}^{*} ‖}_{p} - 1 < 0\end{matrix} ,$$

wherein in the formula, ∇_{U}L(U*, Y*, λ₁, λ₂) is a U space gradient vector of the Lagrangian function L(U, Y, λ₁, λ₂) at the maximum probability failure point, ∇_{Y}L(U*, Y*, λ₁, λ₂) is a Y space gradient vector of the Lagrangian function L (U, Y, λ₁, λ₂) at the maximum probability failure point, and ∇_{λ1}L (U*, Y*, λ₁, λ₂) is a derivative of the Lagrangian function L(U, Y, λ₁, λ₂) with respect to the first Lagrangian multiplier λ₁.

That is, the first KKT condition may be rewritten as:

$$\{ \begin{matrix}{∇}_{U} G ( {U}^{*} , {Y}^{*} ) + {λ}_{1} α = 0 \\ {∇}_{Y} G ( {U}^{*} , {Y}^{*} ) + {λ}_{2} γ = 0 \\ {‖ {U}^{*} ‖}_{2} - {β}^{t} = 0 \\ {λ}_{2} ( {‖ {Y}^{*} ‖}_{p} - 1 ) = 0 \\ {‖ {Y}^{*} ‖}_{p} - 1 < 0\end{matrix} , \\ α = {∇}_{U} ( {‖ {U}^{*} ‖}_{2} - {β}^{t} ) = {U}^{*} / {‖ {U}^{*} ‖}_{2} = {U}^{*} / {β}^{t} , and \\ γ = {∇}_{Y} ( {‖ {Y}^{*} ‖}_{p} - 1 ) = {( {‖ {Y}^{*} ‖}_{p} )}^{1 - p} [ sign ( {Y}_{1}^{*} ) {\vert {Y}_{1}^{*} \vert}^{p - 1} , sign ( {Y}_{2}^{*} ) {\vert {Y}_{2}^{*} \vert}^{p - 1} , … , sign ( {Y}_{{n}_{Z}}^{*} ) {\vert {Y}_{{n}_{Z}}^{*} \vert}^{p - 1} ] ,$$

wherein in the formula, ∇_{U}G(U*, Y*) is a gradient of a maximum displacement function in a U space, ∇_{Y} G (U*, Y*) is a gradient of the maximum displacement function in a Y space, α and γ are respectively gradient vectors of two constraint functions ∥U∥₂−β^{t} and ∥Y∥ₚ−1 at a maximum probability failure point. Therefore, gradients of the maximum displacement function in the U space and the Y space are:

$$\{ \begin{matrix}{∇}_{U} G ( {U}^{*} , {Y}^{*} ) = - {λ}_{1} {U}^{*} / {β}^{t} \\ {∇}_{Y} G ( {U}^{*} , {Y}^{*} ) = 0\end{matrix} .$$

A second norm operation is performed on the foregoing two space gradients to obtain the first Lagrangian multiplier 11, and a corresponding calculation formula is:

$${λ}_{1} = {‖ {∇}_{U} G ( {U}^{*} , {Y}^{*} ) ‖}_{2} .$$

According to the calculated first Lagrangian multiplier λ₁, a first conversion KKT condition that a maximum probability failure point needs to meet in a solving process of the displacement constraint condition G (U, Y) is obtained, and a corresponding calculation formula is:

$$\{ \begin{matrix}{U}^{*} = - {β}^{t} \frac{{∇}_{U} G ( {U}^{*} , {Y}^{*} )}{{‖ {∇}_{U} G ( {U}^{*} , {Y}^{*} ) ‖}_{2}} \\ {∇}_{Y} G ( {U}^{*} , {Y}^{*} ) = 0\end{matrix} .$$

An equivalent single cycle model obtained by performing the equivalence transformation on the back frame lightweight reliability model may be calculated according to the first conversion KKT condition, and a corresponding calculation formula is:

$${min}_{d , {μ}_{X}} M ( d , {μ}_{X} , {μ}_{P} ) , \\ s . t . G ( {U}^{*} , {Y}^{*} ) \geq 0 , \\ {U}^{*} = - {β}^{t} {∇}_{U} G ( {U}^{*} , {Y}^{*} ) / {‖ {∇}_{U} G ( {U}^{*} , {Y}^{*} ) ‖}_{2} , \\ {∇}_{Y} G ( {U}^{*} , {Y}^{*} ) = 0 , and \\ {d}^{l} \leq d \leq {d}^{u} , {μ}_{X}^{l} \leq {μ}_{X} \leq {μ}_{X}^{u} ,$$

A continuously updated maximum probability failure point may be obtained through calculation, and a corresponding calculation formula is:

$${U}^{( k + 1 )} = - {β}^{t} \frac{{∇}_{U} G ( {U}^{( k )} , {Y}^{( k )} )}{{‖ {∇}_{U} G ( {U}^{( k )} , {Y}^{( k )} ) ‖}_{2}} , and \\ \{ \begin{matrix}{∇}_{{Y}_{1}} G ( {U}^{( k + 1 )} , {Y}^{( k + 1 )} ) = 0 \\ {∇}_{{Y}_{2}} G ( {U}^{( k + 1 )} , {Y}^{( k + 1 )} ) = 0 \\ … \\ {∇}_{{Y}_{i}} G ( {U}^{( k + 1 )} , {Y}^{( k + 1 )} ) = 0 \\ … \\ {∇}_{{Y}_{{n}_{Z}}} G ( {U}^{( k + 1 )} , {Y}^{( k + 1 )} ) = 0 \\ {Y}^{( k + 1 )} ∈ ( - 1 , 1 )\end{matrix} ,$$

wherein in the formula, U^{(k+1)} is a first coordinate of an iterative point in a (k+1)^{th} iterative operation process, β^{t} is the target reliability coefficient, ∇_{U}G(U^{(k)}, Y^{(k)}) is a gradient vector of the maximum displacement function G(U^{(k)}, Y^{(k)}) with respect to U, (U^{(k)}, Y^{(k)}) is a k^{th} iterative point in a process of a k^{th} iterative operation, ∇_{Y}_{ᵢ}G (U^{(k+1)}, Y^{(k+1)}) is a partial derivative of the maximum displacement function G(U^{(k)}, Y^{(k)}) with respect to Yᵢ, and Yᵢ is an i^{th} value in the standard interval variable Y, and Y^{(k+1)} is a second coordinate of an iterative point in the (k+1)^{th} iterative operation process.

Step 33: When the preset condition is the second condition, determine a second KKT condition corresponding to a maximum probability failure point according to the second condition and the displacement constraint condition after the Lagrangian transformation, and perform the equivalence transformation on the back frame lightweight reliability model according to the second KKT condition, to calculate maximum probability failure point.

Specifically, for the foregoing maximum probability failure point (U*, Y*) corresponding to the first condition, a necessary and sufficient condition for enabling a second coordinate Y* to be a minimum value in the standard interval variable Y is that a Hessian matrix ∇_{Y}²G(U*, Y*) is a positive definite matrix.

Therefore, when the first condition is not met but the second condition is met, a maximum probability failure point (U*, Y*) needs to meet the following second KKT condition:

$$\{ \begin{matrix}{∇}_{U} L ( {U}^{*} , {Y}^{*} , {λ}_{1} , {λ}_{2} ) = 0 \\ {∇}_{Y} L ( {U}^{*} , {Y}^{*} , {λ}_{1} , {λ}_{2} ) = 0 \\ {∇}_{{λ}_{1}} L ( {U}^{*} , {Y}^{*} , {λ}_{1} , {λ}_{2} ) = 0 \\ {∇}_{{λ}_{2}} L ( {U}^{*} , {Y}^{*} , {λ}_{1} , {λ}_{2} ) = 0\end{matrix} ,$$

wherein in the formula, ∇_{U}L(U*, Y*, λ₁, λ₂) is the U space gradient vector of the Lagrangian function L(U, Y, λ₁, λ₂) at the maximum probability failure point, ∇_{Y}L(U*, Y*, λ₁, λ₂) is the Y space gradient vector of the Lagrangian function L(U, Y, λ₁, λ₂) at the maximum probability failure point, and ∇_{λ}_{₁}L(U*, Y*, λ₁, λ₂) is a derivative of the Lagrangian function L(U, Y, λ₁, λ₂) with respect to the second Lagrangian multiplier λ₂.

That is, the second KKT condition may be rewritten as:

$$\{ \begin{matrix}{∇}_{U} G ( {U}^{*} , {Y}^{*} ) + {λ}_{1} α = 0 \\ {∇}_{Y} G ( {U}^{*} , {Y}^{*} ) + {λ}_{2} γ = 0 \\ {‖ {U}^{*} ‖}_{2} - {β}^{t} = 0 \\ {‖ {Y}^{*} ‖}_{p} - 1 = 0\end{matrix} , \\ α = \frac{{U}^{*}}{{β}^{t}} , and \\ γ = [ sign ( {Y}_{1}^{*} ) {\vert {Y}_{1}^{*} \vert}^{p - 1} , sign ( {Y}_{2}^{*} ) {\vert {Y}_{2}^{*} \vert}^{p - 1} , … , \\ sign ( {Y}_{i}^{*} ) {\vert {Y}_{i}^{*} \vert}^{p - 1} , … , sign ( {Y}_{{n}_{Z}}^{*} ) {\vert {Y}_{{n}_{Z}}^{*} \vert}^{p - 1} ] ,$$

wherein in the formula, Yᵢ* is an i^{th} element of a central point Y* of a maximum probability failure point (U*, Y*), |·|^{p-1} is a (p−1)^{th} power operation of an absolute value, and sign (·) is a mathematical symbol function.

It needs to be noted that, values of the first Lagrangian multiplier λ₁ and the second Lagrangian multiplier λ₂ in this embodiment are greater than or equal to 0.

Therefore, a second norm operation is performed to obtain the first Lagrangian multiplier λ₁, and a corresponding calculation formula is:

$${λ}_{1} = {‖ {∇}_{U} G ( {U}^{*} , {Y}^{*} ) ‖}_{2}$$

The second Lagrangian multiplier may be calculated based on the second KKT condition and the obtained first Lagrangian multiplier λ₁, and a corresponding calculation formula is:

$${∇}_{{Y}_{i}} G ( {U}^{*} , {Y}^{*} ) = - {λ}_{2} sign ( {Y}_{i}^{*} ) {\vert {Y}_{i}^{*} \vert}^{p - 1} , i = 1 , 2 , … , {n}_{Z} ,$$

wherein in the formula, ∇_{Y}_{ᵢ}G(U*, Y*) is a gradient of the maximum displacement function G(U*, Y*) at the maximum probability failure point with respect to U.

Absolute values and p^{th}/(p−1)^{th} powers are calculated on two sides of the foregoing formula to obtain:

$${\vert {∇}_{{Y}_{i}} G ( {U}^{*} , {Y}^{*} ) \vert}^{\frac{p}{p - 1}} = {λ}_{2} {\vert {Y}_{i}^{*} \vert}^{p} , i = 1 , 2 , … , {n}_{Z} .$$

A calculation formula is:

$${( {‖ {Y}^{*} ‖}_{p} )}^{p} = {\vert {Y}_{1}^{*} \vert}^{p} + {\vert {Y}_{2}^{*} \vert}^{p} + … + {\vert {Y}_{{n}_{Z}}^{*} \vert}^{p} = {1}^{p} = 1.$$

Therefore, the second Lagrangian multiplier 12 may be calculated:

$${λ}_{2} = {λ}_{2} {\sum }_{i = 1}^{{n}_{Z}} {\vert {Y}_{i}^{*} \vert}^{p} = {\sum }_{i = 1}^{{n}_{Z}} {λ}_{2} {\vert {Y}_{i}^{*} \vert}^{p} = {\sum }_{i = 1}^{{n}_{Z}} {\vert {∇}_{{Y}_{i}} G ( {U}^{*} , {Y}^{*} ) \vert}^{\frac{p}{p - 1}} .$$

In this case, a second conversion KKT condition corresponding to the second KKT condition is:

$$\{ \begin{matrix}{U}^{*} = - {β}^{t} \frac{{∇}_{U} G ( {U}^{*} , {Y}^{*} )}{{‖ {∇}_{U} G ( {U}^{*} , {Y}^{*} ) ‖}_{2}} \\ \begin{matrix}{Y}_{i}^{*} = - sign ( {∇}_{{Y}_{i}} G ( {U}^{*} , {Y}^{*} ) ) {\vert \frac{{∇}_{{Y}_{i}} G ( {U}^{*} , {Y}^{*} )}{{\sum }_{i = 1}^{{n}_{Z}} {\vert {∇}_{{Y}_{i}} G ( {U}^{*} , {Y}^{*} ) \vert}^{\frac{p}{p - 1}}} \vert}^{\frac{1}{p - 1}} , \\ i = 1 , 2 , … , {n}_{Z}\end{matrix}\end{matrix} .$$

An equivalent single cycle model obtained by performing the equivalence transformation on the back frame lightweight reliability model may be calculated according to the second conversion KKT condition, and a corresponding calculation formula is:

$${min}_{d , {μ}_{X}} M ( d , {μ}_{X} , {μ}_{P} ) , \\ s . t . G ( {U}^{*} , {Y}^{*} ) \geq 0 , \\ {U}^{*} = - {β}^{t} \frac{{∇}_{U} G ( {U}^{*} , {Y}^{*} )}{{‖ {∇}_{U} G ( {U}^{*} , {Y}^{*} ) ‖}_{2}} , \\ {Y}_{i}^{*} = - sign ( {∇}_{{Y}_{i}} G ( {U}^{*} , {Y}^{*} ) ) {\vert \frac{{∇}_{{Y}_{i}} G ( {U}^{*} , {Y}^{*} )}{{\sum }_{i = 1}^{{n}_{Z}} {\vert {∇}_{{Y}_{i}} G ( {U}^{*} , {Y}^{*} ) \vert}^{\frac{p}{p - 1}}} \vert}^{\frac{1}{p - 1}} , \\ i = 1 , 2 , … , {n}_{Z} , and \\ {d}^{l} \leq d \leq {d}^{u} , {μ}_{X}^{l} \leq {μ}_{X} \leq {μ}_{X}^{u} .$$

A continuously updated maximum probability failure point may be obtained through calculation, and a corresponding calculation formula is:

$${U}^{( k + 1 )} = - {β}^{t} \frac{{∇}_{U} G ( {U}^{( k )} , {Y}^{( k )} )}{{‖ {∇}_{U} G ( {U}^{( k )} , {Y}^{( k )} ) ‖}_{2}} , \\ {Y}_{i}^{( k + 1 )} = - sign ( {∇}_{{Y}_{i}} G ( {U}^{( k + 1 )} , {Y}^{( k )} ) ) {\vert \frac{{∇}_{{Y}_{i}} G ( {U}^{( k + 1 )} , {Y}^{( k )} )}{{\sum }_{i = 1}^{{n}_{Z}} {\vert {∇}_{{Y}_{i}} G ( {U}^{( k + 1 )} , {Y}^{( k )} ) \vert}^{\frac{p}{p - 1}}} \vert}^{\frac{1}{p - 1}} , and \\ i = 1 , 2 , … , {n}_{Z} .$$

Step 34: Calculate a solution of a certainty model part in the back frame lightweight reliability model according to the calculated maximum probability failure point, wherein the solution is denoted as the optimal solution of the back frame lightweight reliability model. A calculation formula of the certainty model part in the back frame lightweight reliability model is:

$${min}_{{d}^{( k )} , {μ}_{X}^{( k )}} M ( {d}^{( k )} , {μ}_{X}^{( k )} , {μ}_{P} ) , \\ s . t . G ( {U}^{( k )} , {Y}^{( k )} ) \geq 0 , and \\ {d}^{l} \leq {d}^{( k )} \leq {d}^{u} , {μ}_{X}^{l} \leq {μ}_{X}^{( k )} \leq {μ}_{X}^{u} ,$$

wherein in the formula, (d^{(k)}, μ_{X}^{(k)}) is an optimal solution in the process of the k^{th} iterative operation, and d^{(k)} and μ_{X}^{(k)} are design points that need to be solved in a k^{th} iterative step. The solution (d^{(k)}, μ_{X}^{(k)}) can be obtained by solving the model.

$$G ( {U}^{( k )} , {Y}^{( k )} ) = {δ}_{0} - δ ( {d}^{( k )} , T ( {U}^{( k )} , {θ}^{( k )} ) ) = {δ}_{0} - δ ( {d}^{( k )} , ( {μ}_{X}^{( k )} , {μ}_{P} ) - {s}^{( k )} ) ,$$

wherein s^{(k)} is set as a drift vector, and s^{(k)}=(μ_{X}^{(k-1)}, μₚ)−T(U^{(k)}, θ^{(k)}), to facilitate understanding of the formula, and an average value of a cumulative distribution function in a standardization function T(·) is μX^{(k-1)}.

Further, said step 3 further includes:
when it is determined that a k^{th} maximum probability failure point calculated in the k^{th} iterative operation converges, calculating the optimal solution of the back frame lightweight reliability model according to the k^{th} maximum probability failure point, wherein a calculation formula for determining whether the k^{th} maximum probability failure point converges is:

$$G ( {U}^{( k )} , {Y}^{( k )} ) \geq - {ε}_{1} , and \\ \vert \frac{M ( {d}^{( k )} , {μ}_{X}^{( k )} , {μ}_{P} ) - M ( {d}^{( k - 1 )} , {μ}_{X}^{( k - 1 )} , {μ}_{P} )}{M ( {d}^{( k )} , {μ}_{X}^{( k )} , {μ}_{P} )} \vert \leq {ε}_{2} ,$$

wherein in the formula, −ε₁ is an error upper threshold, ε₂ is an error lower threshold, G(·) is a corresponding displacement constraint condition when the k^{th} iterative operation, U^{(k)} is a standard normal random variable in the process of the k^{th} iterative operation, Y^{(k)} is a standard interval variable in the process of the k^{th} iterative operation, M(·) is the lightweight reliability model of back frame of phased array radar antenna, (d^{(k)}, μ_{X}^{(k)})) is an optimal solution in the process of the k^{th} iterative operation, d^{(k)} is a certainty optimization variable in the process of the k^{th} iterative operation, μ_{X}^{(k)} is an average value of the uncertainty optimization variable in the process of the k^{th} iterative operation, and up is an average value of an uncertainty parameter.

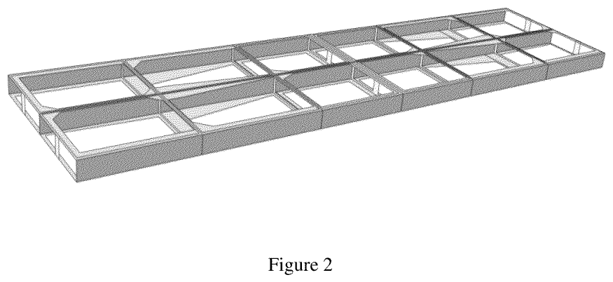

To verify the foregoing lightweight method in this embodiment, as shown in FIG. 2, it is set that M40 carbon fiber is used for the back frame of phased array radar antenna, an overall size is 8 m×2 m, and a quantity of antenna elements is 32×24=768.

Uncertainties (for example, a shell thickness, an installation error, a wind load direction, and an environmental temperature) are measured for existing sample data, to obtain a cumulative distribution density function corresponding to the sample data, as shown in Table 1.

TABLE 1

| | | Mean | | |
|---|---|---|---|---|
| Parameter type | Symbol | value | Variance | Distribution type |
| Shell thickness | X₁ (mm) | 8 | [0.04, 0.05] | Normal distribution |
| Installation error | X₂ (mm) | 0 | [5, 6] | Normal distribution |
| Wind load | X₃ (°) | 90 | [20, 25] | Normal distribution |
| direction | | | | |
| Environmental | X₄ (° C.) | 20 | [15, 20] | Normal distribution |
| temperature | | | | |

It is set that: model parameter R^{t}=0.99, the displacement threshold 80=2.5, and the corresponding back frame lightweight reliability model is:

$${min}_{d , {μ}_{X}} M ( d , {μ}_{X} , {μ}_{P} ) , \\ s . t . Pr ( {δ}_{0} - δ ( d , Z ( {θ}_{Z}^{I} ) ) \geq 0 ) \geq 0.99 , \\ {d}^{l} \leq d \leq {d}^{u} , {μ}_{X}^{l} \leq {μ}_{X} \leq {μ}_{X}^{u} , \\ {θ}_{X}^{I} = [ {θ}_{X}^{l} , {θ}_{X}^{u} ] , {θ}_{P}^{I} = [ {θ}_{P}^{l} , {θ}_{P}^{u} ] , {δ}_{0} = 2.5 , and \\ Z ( {θ}_{Z}^{I} ) = ( X ( {θ}_{X}^{I} ) , P ( {θ}_{P}^{I} ) ) , {θ}_{Z}^{I} = ( {θ}_{X}^{I} , {θ}_{P}^{I} ) .$$

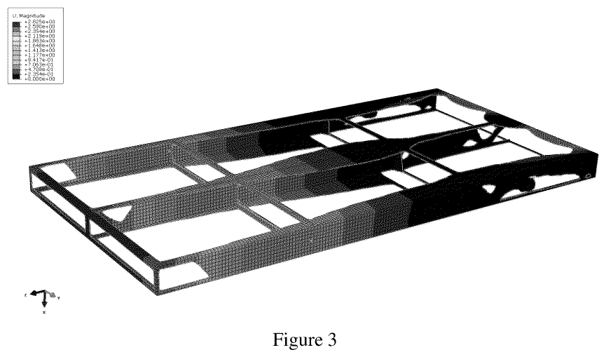

Subsequently, a single cycle method provided in the present application is used to solve the foregoing lightweight model and finally obtain a group of optimal solutions. As shown in FIG. 3, compared with an original back frame, a weight is reduced by approximately 100 kg. In addition, in a case that a probability of a back frame deformation maximum value is 99%, a requirement of a peak value of 2.5 mm is not exceeded.

The technical solution of the present application is described in detail above with reference to the accompanying drawings.

The present application provides a lightweight method for a back frame of phased array radar antenna, including: step 1: establishing a lightweight reliability model of back frame of phased array radar antenna based on measured parameters of a back frame of phased array radar antenna and by using an interval-probability uncertainty measurement model; step 2: calculating, based on an equivalence model principle and according to a displacement function of the back frame of antenna in the lightweight reliability model of back frame of phased array radar antenna, a reliability that a displacement amount maximum value of the back frame of antenna does not exceed a displacement threshold, and performing a conversion operation on the reliability based on a reliability lower boundary to calculate a displacement constraint condition; and step 3: performing a Lagrangian transformation on the displacement constraint condition, calculating a maximum probability failure point of a displacement constraint condition after the Lagrangian transformation under a preset condition by using an iterative operation, and calculating an optimal solution of the back frame lightweight reliability model according to the maximum probability failure point, to determine a phased array radar antenna lightweight reliability parameter. Through the technical solution in the present application, structural reliability of a back frame of phased array radar antenna is measured and optimized by using an interval-probability uncertainty measurement model, using a minimum total weight of a back frame as a target function, and using limited samples. The problem that it is difficult to obtain an accurate probability model of a back frame of phased array radar antenna is resolved, thereby greatly reducing a calculation amount in a reliability optimization process.

According to an actual requirement, the steps in the present application may be rearranged, combined or deleted.

According to an actual requirement, the units of the apparatus in the present application may be combined, divided or deleted.

Although the present application is disclosed in detail with reference to the accompanying drawings, it should be understood that these descriptions are merely exemplary but are not intended to limit the application of the present application. The protection scope of the present application is defined by the appended claims, and may include various variations, modifications, and equivalent solutions made to the invention without departing from the protection scope and spirit of the present application.

1. A lightweight method for a back frame of phased array radar antenna, wherein said method comprises steps of:
step 1: establishing a lightweight reliability model of back frame of phased array radar antenna based on measured parameters of a back frame of phased array radar antenna, by using an interval-probability uncertainty measurement model;
step 2: calculating, based on an equivalence model principle and according to a displacement function of the back frame of antenna in the lightweight reliability model of back frame of phased array radar antenna, a reliability indicating that a displacement amount maximum value of the back frame of antenna does not exceed a displacement threshold, and performing a conversion operation on the reliability based on a reliability lower boundary to calculate a displacement constraint condition; and
step 3: performing a Lagrangian transformation on the displacement constraint condition, calculating a maximum probability failure point of a displacement constraint condition after the Lagrangian transformation under a preset condition by using an iterative operation, and calculating an optimal solution of the back frame lightweight reliability model according to the maximum probability failure point, to determine a phased array radar antenna lightweight reliability parameter.

2. The lightweight method for a back frame of phased array radar antenna according to claim 1, wherein said step 2 comprises:
step 21: converting an uncertainty variable in the lightweight reliability model of back frame of phased array radar antenna into a standard normal random variable;
step 22: equivalently replacing a reliability coefficient of the reliability with a reliability coefficient lower boundary; and
step 23: calculating the displacement constraint condition corresponding to an index lower boundary of the displacement function based on an equivalently replaced reliability.

3. The lightweight method for a back frame of phased array radar antenna according to claim 2, wherein a calculation formula of the displacement constraint condition is:
$${min}_{U , Y} G ( U , Y ) , \\ s . t . {‖ U ‖}_{2} = {β}^{t} , and \\ {‖ Y ‖}_{p} \leq 1 ,$$
wherein in the formula, G (U, Y) is the displacement constraint condition, U is the standard normal random variable, ∥ ∥₂ is a second norm of a vector, β^{t} is a target reliability coefficient, p is a hyperparameter, ∥·∥ₚ is a p norm operation of a vector, and Y is a standard interval variable.

4. The lightweight method for a back frame of phased array radar antenna according to claim 1, wherein the preset condition is one of a first condition and a second condition, and said step 3 comprises:
step 31: calculating initial design parameter(s) of the back frame of phased array radar antenna in certainty parameter;
step 32: when the preset condition is the first condition, determining a corresponding first KKT condition according to the first condition and a displacement constraint condition after the Lagrangian transformation, and performing an equivalence transformation on the back frame lightweight reliability model according to the first KKT condition, to calculate the maximum probability failure point; and
step 34: calculating a solution of a certainty model part in the back frame lightweight reliability model according to the calculated maximum probability failure point, and the solution is denoted as the optimal solution of the back frame lightweight reliability model.

5. The lightweight method for a back frame of phased array radar antenna according to claim 4, wherein said step 3 specifically further comprises:
step 33: when the preset condition is the second condition, determining a corresponding second KKT condition according to the second condition and the displacement constraint condition after the Lagrangian transformation, and performing the equivalence transformation on the back frame lightweight reliability model according to the second KKT condition, to calculate the maximum probability failure point.

6. The lightweight method for a back frame of phased array radar antenna according to claim 4, wherein said step 3 further comprises:
when it is determined that a k^{th} maximum probability failure point calculated in a k^{th} iterative operation converges, calculating the optimal solution of the back frame lightweight reliability model according to the k^{th} maximum probability failure point, wherein a calculation formula for determining whether the k^{th} maximum probability failure point converges is:
$$G ( {U}^{( k )} , {Y}^{( k )} ) \geq - {ε}_{1} , and \\ \vert \frac{M ( {d}^{( k )} , {μ}_{X}^{( k )} , {μ}_{P} ) - M ( {d}^{( k - 1 )} , {μ}_{X}^{( k - 1 )} , {μ}_{P} )}{M ( {d}^{( k )} , {μ}_{X}^{( k )} , {μ}_{P} )} \vert \leq {ε}_{2} ,$$
wherein in the formula, −ε₁ is an error upper threshold, ε₂ is an error lower threshold, G(·) is a corresponding displacement constraint condition when the k^{th} iterative operation, U^{(k)} is a standard normal random variable in a process of the k^{th} iterative operation, Y^{(k)} is a standard interval variable in the process of the k^{th} iterative operation, M(·) is the lightweight reliability model of back frame of phased array radar antenna, (d^{(k)}, μ_{X}^{(k)}) is an optimal solution in the process of the k^{th} iterative operation, d^{(k)} is a certainty optimization variable in the process of the k^{th} iterative operation, μ_{X}^{(k)} is an average value of an uncertainty optimization variable in the process of the k^{th} iterative operation, and Up is an average value of uncertainty parameter.

7. The lightweight method for a back frame of phased array radar antenna according to any one of claims 1 to 6, wherein a calculation formula of the lightweight reliability model of back frame of phased array radar antenna is:
$${min}_{d , {μ}_{X}} M ( d , {μ}_{X} , {μ}_{P} ) , \\ s . t . Pr ( {δ}_{0} - δ ( d , Z ( {θ}_{Z}^{I} ) ) \geq 0 ) \geq {R}^{t} , \\ {d}^{l} \leq d \leq {d}^{u} , {μ}_{X}^{l} \leq {μ}_{X} \leq {μ}_{X}^{u} , \\ Z ( {θ}_{Z}^{I} ) = ( X ( {θ}_{X}^{I} ) , P ( {θ}_{P}^{I} ) ) , {θ}_{Z}^{I} = ( {θ}_{X}^{I} , {θ}_{P}^{I} ) , and \\ {θ}_{X}^{I} = [ {θ}_{X}^{l} , {θ}_{X}^{u} ] , {θ}_{P}^{I} = [ {θ}_{P}^{l} , {θ}_{P}^{u} ] ,$$
in the formula, M (d, μ_{X}, μₚ) is a total weight of the back frame of antenna, and at the same time is also a back frame lightweight target function, d is a certainty optimization variable, μ_{X} is an average value of an uncertainty optimization variable X(θ_{X}^{I}), μₚ is the average value of the uncertainty parameter P(θ_{P}^{I}), Pr(·) is a probability measure, δ₀ is the displacement threshold, δ(·) is the displacement function of the back frame of antenna, Z(θ_{Z}^{l}) is the uncertainty variable in the back frame lightweight reliability model, R^{t} is a reliability parameter indicating that the displacement amount maximum value of the back frame of antenna does not exceed the displacement threshold, θ_{Z}^{I} is a first parameter, and is determined by a second parameter θ_{X}^{I} and a third parameter θ_{P}^{I}, (·)^{l} is a lower boundary of a parameter, and (·)^{u} is an upper boundary of a parameter.
